(19) United States
(12) Patent Application Publication
(10) Pub. No.: US 2007/0234859 A1
(43) Pub. Date: Oct. 11, 2007

(54) Method of Punching an Opening into a Work Piece

(76) Inventors: Uwe Winkler, Sulzbach (DE); Harry Gau, Ingbert (DE)

Correspondence Address: MAGNA INTERNATIONAL, INC., 337 MAGNA DRIVE, AURORA, ON, L4G-7K1, US

(21) Appl. No.: 11/697,763

(22) Filed: Apr. 9, 2007

(30) Foreign Application Priority Data
Apr. 11, 2006 (DE) 102006017939.0

(51) Int. Cl. B26D 1/00

(52) U.S. Cl. 83/13; 83/52

(57) ABSTRACT

A process for perforating workpieces and a tool for carrying out this process are envisaged. In the process described it is envisaged that a cutting tool is used to make an opening in a workpiece and stamping is carried out in the region of a cut edge of the opening purely by interlocking and frictional engagement.

### CROSS-REFERENCE TO RELATED APPLICATIONS

This application claims the benefit of German Patent Application Serial No. 102006017939.0, filed on Apr. 11, 2006 and entitled “Verfahren zum Lochen von Werkstücken” (Method of Punching an Opening into a Work Piece), the disclosure of which is incorporated herein by reference.

### FIELD OF THE INVENTION

The invention relates to a process for perforating workpieces and a tool for carrying out this process.

### BACKGROUND OF THE INVENTION

Flat mouldings made of plastics are common in motor cars. With flat parts, in particular, openings have to be formed in them to accommodate functional units, requiring the use of suitable tools. Depending on the particular application the necessary openings have to be provided before or after the surface of the component is painted or varnished.

For forming the openings, cutting tools have been designed which can be included in automatic production processes. However, one disadvantage which has become apparent is that shaping defects occur on the cut surfaces formed by the cutting as a result of the withdrawal of the edge and the formation of burrs and cracks, which both detract from the desired uniform appearance and also affect the strength of the components.

With thermoplastic plastics, e.g. injection moulded parts, it is known to carry out a thermoforming process by applying a heated moulding surface in the region of the cut edge.

The publication DE 197 30 859 A1 discloses for example a cutting tool and a process for perforating workpieces made of thermoplastic plastics. The cutting tool described has a blade running around its end face, which can be brought into engagement with a cutting plate in one operation and penetrates the workpiece arranged between its blade and the cutting plate, with a perforating punch, thereby producing a hole in the wall in the direction of cutting. This perforating punch has a thermoforming surface arranged counter to the blade and projecting beyond it at right angles to the cutting direction and heatable by means of a heating device, said thermoforming surface being adapted to be applied against the cut edge of the wall opening at the end of the operation.

However, owing to the heat treatment carried out, the process described is only suitable for workpieces that can be exposed to the action of heat. A workpiece made of a polyurethane, for example, cannot be subjected to thermal processing of this kind.

### SUMMARY OF THE INVENTION

The process according to the invention for perforating workpieces, particularly workpieces which cannot be subjected to temperature treatment, envisages that in one operation a cutting tool is used to make an opening in the workpiece and moreover stamping is carried out in the region of a cutting or cut edge of the opening purely by interlocking and frictional engagement with the cutting tool.

The making of the hole and the stamping in the region of the cut edge and hence in the region of the rim of the hole formed are preferably carried out in the same operation, i.e. in a single operation. The punching process is typically carried out before the stamping process. It is also possible for the two processes of punching and stamping to at least partially overlap in time.

The process according to the invention can be carried out before or after the surface is painted. When the process is carried out before painting, the circumscribed stamping process ensures that the surface of the workpiece can be pre-treated in a manner which is favourable for the subsequent painting. If the process according to the invention is carried out after painting, it is ensured that the paint is not damaged and also no so-called “paint tears” are formed on the stamped openings.

The process according to the invention may be carried out for example on a workpiece made of a polyurethane or a polyurethane elastomer. The punching force used is selected according to the thickness of the material. Typical values are between 1.5 and 7 t (metric). It should be noted that the process according to the invention can be used to treat workpieces that would be damaged by heat treatment.

According to one feature, the tool used is a perforating punch having an encircling blade and a shaping surface which projects over the blade, at right angles to a cutting direction, and can be pressed against the cutting edge. The configuration of the blade or cutting edge determines the contour of the opening produced. During punching, the cutting edge engages in the workpiece. Depending on the length of the working stroke, a complete opening or only a partial opening and hence a recess may be produced in the workpiece.

The shaping surface which does the stamping by pressing against the workpiece in the region of the cut edge may for example be curved, forming a radius. Alternatively, the shaping surface may be shaped into a chamfer. However, other designs of the shaping surface are possible, the construction of the shaping surface determining the form and nature of the cut edge after the process has been carried out. This shape is regularly adapted to the construction of the functional unit which is to be inserted.

The tool according to the invention for perforating workpieces is used in particular for carrying out the process described hereinbefore, by making an opening in the workpiece. Tool steel is an appropriate material for the perforating punch.

The tool is constructed, for example, as a perforating punch with an encircling blade and a shaping surface that extends beyond the blade, at right angles to a cutting direction, which can be pressed against the cut edge, so that stamping or cold forming take place in the region of the cut edge of the opening purely as a result of interlocking and frictional engagement. There is no need for a temperature process to achieve the desired results.

Depending on the application, the shaping surface may be smooth or may have a structure, e.g. a grooved surface. This structure affects the nature of the surface of the workpiece around the rim of the opening. Thus, the surface can be pre-treated in this way for subsequent machining operations.

Further features and embodiments of the invention will become apparent from the description and the attached drawings.

It will be understood that the features mentioned above and those which will be described below may be used not only in the combination specified but also in other combinations or on their own, without departing from the scope of the present invention.

### BRIEF DESCRIPTION OF THE DRAWINGS

The invention is schematically illustrated in the drawings by means of exemplary embodiments and is described in detail hereinafter with reference to the drawings, wherein:

FIG. 1 shows a preferred embodiment of the tool according to the invention;

FIG. 2 shows a workpiece made of a polyurethane in sectional view;

FIG. 3 shows a workpiece punched according to the prior art in sectional view; and

FIG. 4 shows a workpiece punched according to the invention in sectional view.

### DETAILED DESCRIPTION OF THE PREFERRED EMBODIMENTS

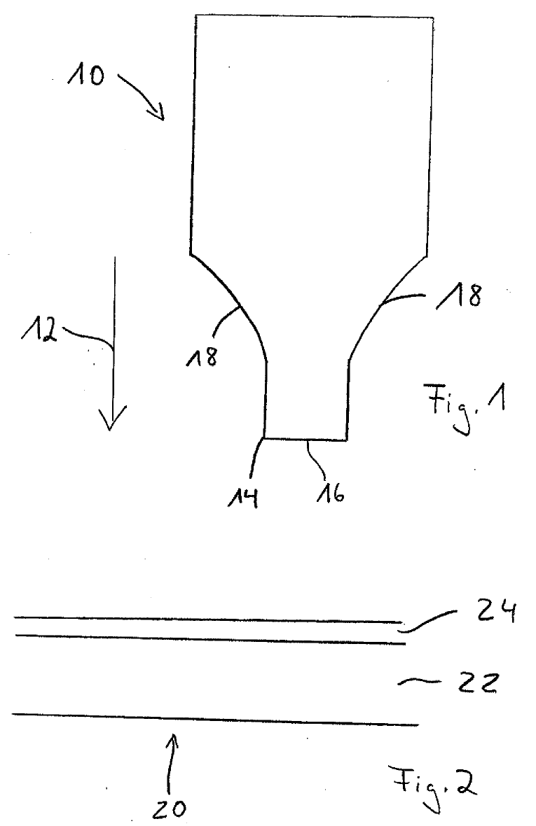

FIG. 1 shows a preferred embodiment of the tool according to the invention, in this case a perforating punch designated 10, which is intended for use in the process according to the invention. When the perforating punch 10 is used, it is moved in the cutting direction indicated by an arrow 12 towards a workpiece (not shown) which is to be machined. A preferably sharp-edged typically rotating blade or cutting edge 14 penetrates into the workpiece and produces the desired opening in one punching operation. The cross-section of the opening is determined by the cross-section of a front part 16 of the stamping punch 10 which is surrounded by the cutting edge 14.

Also, a curved shaping surface 18 is provided which, spaced from the blade 14, projects over it at right angles to the cutting direction 12. This shaping surface 18 is usually pressed against the workpiece in the region of the cutting edge, i.e. in the region of the rim of the punched-out opening or hole, in the same operation in which the punching is carried out, and in a stamping process brings about cold deformation of the workpiece in this region by interlocking and frictional engagement. As a result of the curved or bent formation of the shaping surface a radius is formed in the region of the cutting edge, as well as a smooth crack-free cutting edge.

FIG. 2 shows in sectional view a flat workpiece made of a polyurethane material, generally designated 20. This workpiece 20 has a relatively porous base part 22 and an integral skin 24. This integral skin 24 is sensitive to external influences and is destroyed by a heating process, for example. Therefore, it is important that this workpiece is not subjected to any temperature treatment and hence not to any warm or hot stamping either. The workpiece 20 may be painted by applying a coat of paint to the integral skin 24 before or after the perforation of the workpiece 20.

The thickness of the workpiece 20 determines the force needed for the punching. In a controlled process, the force with which the tool is pressed against the workpiece 20 can be set or controlled or even regulated.

FIG. 3 shows a workpiece 30 in which an opening 32 has been made using a process according to the prior art. Also shown is a coat of paint 34 which was applied before the punching process.

In the region of a cut edge 36, i.e. in the region of the rim zone of the opening 32, a sharp edge has been formed, particularly in the coat of paint 34, leading to an unsatisfactory appearance and hence to higher rejection rates.

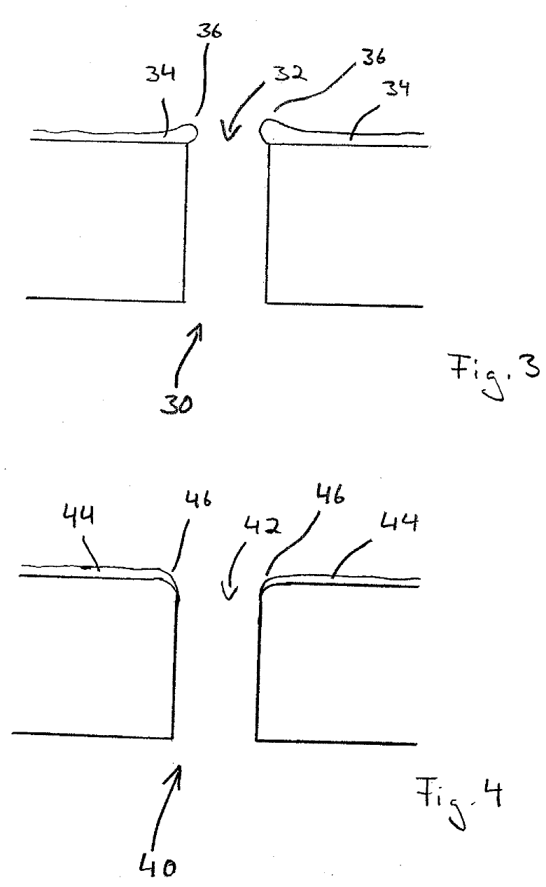

FIG. 4 shows another workpiece 40 in which an opening 42 has been formed according to the invention. This workpiece 40 is also covered with a coat of paint 44.

It is clear that both the workpiece 40 and the coat of paint 44 have been stamped in the region of a cut edge 46 and have been formed with a radius. The cut edge 46 is therefore smooth and free from cracks.

This stamping is carried out according to the invention solely by cold forming using a contour on the punching die, so that the workpiece 40, the coat of paint 44 and any integral skin provided are not damaged.

The process according to the invention achieves a better consistency from one part to another, including the external appearance, and thus reduces the rejection rate. It can be carried out before or after painting. If the process according to the invention and hence the punching are carried out after painting, the production of variants before painting is no longer needed, which is a logistical advantage.

It should be appreciated that the foregoing description is illustrative in nature and that the present invention includes modifications, changes, and equivalents thereof, without departure from the scope of the invention.

What is claimed is:

1. A process for perforating workpieces, wherein a cutting tool is used to make an opening in a workpiece in one operation and furthermore stamping is carried out in the region of a cut edge of the opening purely by interlocking and frictional engagement with the cutting tool.

2. A process according to claim 1, wherein the formation of the opening and the stamping are carried out in the same operation.

3. A process according to claim 1, which is carried out before the surface of the workpiece is painted.

4. A process according to claim 1, which is carried out after the surface of the workpiece is painted.

5. A process according to claim 1, wherein a workpiece made of a polyurethane is perforated.

6. A process according to claim 1, wherein the tool used is a perforating punch with an encircling blade and a shaping surface that projects over the blade at right angles to a direction of cutting and can be pressed against the cut edge.

7. A process according to claim 6, wherein the shaping surface is curved, forming a radius.

8. A process according to claim 6, wherein the shaping surface is shaped to form a chamfer.

9. A tool for perforating workpieces, particularly for carrying out a process according to claim 1, for making an opening in the workpiece.

10. A tool according to claim 9 which is constructed as a perforating punch with an encircling blade and a shaping surface that extends beyond the blade, at right angles to a cutting direction, which can be pressed against the cut edge, so that stamping takes place in the region of the cut edge of the opening purely as a result of interlocking and frictional engagement.

11. A tool according to claim 10, wherein the perforating punch is made from a tool steel.

12. A tool according to claim 10, wherein the shaping surface is smooth.

13. A tool according to claim 10, wherein the shaping surface has a structure.
